(19) United States
(12) Patent Application Publication
(10) Pub. No.: US 2007/0291666 A1
(43) Pub. Date: Dec. 20, 2007

(54) Method for designing optical network, optical network, and computer readable medium

(75) Inventors: Toru Katagiri, Kawasaki (JP); Kazuyuki Tajima, Kawasaki (JP); Tomohiro Hashiguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/705,582

(22) Filed: Feb. 13, 2007

(30) Foreign Application Priority Data
Jun. 14, 2006 (JP) 2006-165008

(51) Int. Cl. H04L 12/28

(52) U.S. Cl. 370/258

(57) ABSTRACT

An appropriate ring topology is selected by searching network topology information on the basis of given information about client signal paths on a predetermined condition, and a wavelength ring accommodating the client signal paths and having an optimal transmission characteristic is designed on the basis of the selected ring topology. Accordingly, accommodation of client signal paths in an optical network is efficiently designed.

### CROSS-REFERENCE TO RELATED APPLICATION

This application is related to Japanese patent application No. 2006-123908 filed Apr. 27, 2006, the entire contents of which are hereby incorporated by reference.

### BACKGROUND OF THE INVENTION

1. Field of the Invention

The present invention relates to a technique of designing an optical network and particularly to a method for designing an optical network, an optical network, and a recording medium, adapted to efficiently accommodate paths of various client signals in an optical network of diversified network topology, such as ring, ring interconnection, and mesh.

2. Description of the Related Art

In optical networks represented by a WDM (Wavelength Division Multiplexing) network, paths of various client signals need to be accommodated.

Examples of the client signals include a SONET (ANSI T1.105 recommendation: Synchronous Optical Network Basic Description Including Multiplex Structure, Rates, and Formats) signal; an SDH (ITU-T recommendation G.803: Architecture of Transport Networks Based on The Synchronous Digital Hierarchy) signal; a Gb Ethernet® signal; a 10 Gb Ethernet® signal; and a Fiber Channel signal.

In recent years, an optical transmission/reception card for a WDM transmitting device having both branching/inserting function and transponder function for SONET signals and SDH signals (hereinafter referred to as SONET/SDH signals) has been developed, so that a SONET/SDH network can be established on a WDM network by using only a WDM transmitting device.

Conventionally, a SONET/SDH network has been established on a WDM network by individually preparing a WDM transmitting device for transmitting WDM signals and a SONET/SDH ADM (Add-Drop Multiplexer) device for transmitting SONET/SDH signals and by using the both devices. Furthermore, the networks thereof have been independently designed on respective WDM network and SONET/SDH network layers.

In the following description, the WDM network is used as a representative example of optical networks, and the SONET signal is used as a representative example of client signals. However, other types of optical networks and other types of client signals, such as SDH signals, can also be applied.

When a path of SONET signals is to be accommodated in the WDM network, the path in the WDM network through which the SONET signals pass needs to be in a form of ring topology considering protection against abnormal transmission (e.g., failure in a device, increased loss in lines, or disconnection).

In order to actually accommodate a path of the SONET signals in a ring topology, a wavelength ring of a predetermined band (e.g., a wavelength ring of 10 Gbps), which is a ring path for accommodating a bundle of client signal paths, needs to be assigned in the ring topology.

Then, respective client signal paths are accommodated in the assigned wavelength ring while considering the bandwidths of the respective signals. Thus, a plurality of wavelength rings may be assigned to one ring topology.

When a path of SONET signals is to be accommodated in the WDM network, network topology information is established by inputting information about a connection relationship among nodes in the WDM network to be designed. Then, all ring topologies that can exist on the WDM network are searched for on the basis of the network topology information and are held.

When a wavelength ring is to be assigned on the WDM network, a ring topology that is determined to be optimal by a designer is selected from among the searched and held ring topologies, and then a wavelength ring to accommodate, for example, ring paths of the SONET network is assigned on the selected ring topology. That is, accommodation design is performed on the basis of information about transmitting end nodes and receiving end nodes and signal bandwidths included in information of respective client signal paths so that the number of wavelength rings in the WDM network is the smallest and that the total amount of optical transmission/reception cards mounted on respective nodes required to accommodate the client signal paths is the smallest.

Also, optimization considering a transmission characteristic, e.g., the length of a wavelength ring to accommodate client signal paths is shortened as much as possible, is required. A ring topology satisfying the requirement needs to be selected from among many ring topologies through determination made by a designer.

A technique of automatically designing a network transmission path including ring protection is disclosed in Patent Document 1 (Japanese Unexamined Patent Application Publication No. 2000-232472).

The following problems may arise when paths of client signals such as SONET/SDH signals are to be accommodated in an optical network, such as the WDM network.

(1) It takes a lot of time to search for all ring topologies when the network topology is complicated.

(2) In a large scale of network where the number of all ring topologies is large, there exist a plurality of ring topologies capable of accommodating a SONET/SDH path. In that case, accommodation design needs to be performed by determining an optimal ring topology to accommodate the SONET/SDH path. However, the determination requires a lot of time, which inhibits efficient designing.

### SUMMARY OF THE INVENTION

The present invention is directed to providing a method for designing an optical network, an optical network, and a recording medium, for efficiently performing accommodation of client signal paths in an optical network by selecting a ring topology adapted to given client signal paths from a network topology on a predetermined condition and by assigning one or more wavelength rings that optimally accommodate the client signal paths in the selected ring topology.

According to one aspect of the present invention, there is provided a method comprising providing network topology information defining a connection relationship between nodes of the optical network, providing client signal path information for each client signal path, the client signal path information including end node identification information and path bandwidth information, the end node identification information identifying a pair of end nodes comprising a transmitting end node and a receiving end node of the client signal path, the path bandwidth information indicating a bandwidth of the client signal path between the pair of end nodes, a first path subset selecting step of selecting a first path subset of a total path set of client signal paths to be accommodated in the optical network, a first ring selecting step of selecting a first ring topology including end nodes of all client signal paths included in the first path subset, a first path expanding step of expanding the first path subset into a second path subset of the total path set by adding to the first path subset an additional client signal path that is not included in the first path subset and that has at least one node of the first ring topology as an end node thereof, and a first ring expanding step of searching the network topology information for a second ring topology on a predetermined condition, the second ring topology including all nodes of the first ring topology and a pair of end nodes of the additional client signal path.

Accordingly, when a ring topology capable of accommodating a set of client signal paths is given, the set of client signal paths can be expanded. Also, the given ring topology can be corrected so as to accommodate the expanded set of client signal paths and to satisfy a predetermined condition.

The predetermined condition may include, for example, (1) connection links between the respective nodes in the optical network are weighted, and the distance of a ring topology calculated on the basis of the weight is the shortest; (2) the total number of hops in the ring topology is the smallest; and (3) OSNR (Optical Signal-Noise Ratio) of the ring topology is the largest.

According to another aspect of the present invention, there is provided a method further comprising a second path subset selecting step of selecting the second path subset as a first path subset, a second ring selecting step of selecting the second ring topology as a first ring topology, a second path expanding step of expanding the first path subset into a second path subset by performing the first path expanding step on the first path subset selected by the second path subset selecting step, a second ring expanding step of expanding the first ring topology into the second ring topology by performing the first ring expanding step on the first ring topology selected by the second ring selecting step, and a expansion repeating step of repeating the second path subset selecting step, the second ring selecting step, the second path expanding step, and the second ring expanding step, until the first path subset cannot be expanded any more or until the first ring topology cannot be expanded any more.

In this case, the second path subset selecting step can select, as a first path subset, an initial client signal path from the total path set of client signal paths, the second ring selecting step can select, as the first ring topology, a ring topology including a pair of end nodes of the selected client signal path, and the second path subset and the second ring topology obtained by the expansion repeating step are determined to be an expanded path subset and an expanded ring topology of the selected initial client signal path, respectively.

Accordingly, by specifying an initial client signal path in the entire set of client signal paths to be accommodated in the optical network, a largest set of client signal paths (expanded subset of client signal paths) that includes the specified client signal path and that can be accommodated in a ring topology satisfying the predetermined condition; and a ring topology (expanded ring topology) capable of accommodating the expanded subset of client signal paths and satisfying the predetermined condition can be obtained at the same time.

According to still another aspect of the present invention, there is provided a method further comprising assigning to the expanded ring topology one or more wavelength rings each having a predetermined wavelength and bandwidth, accommodating each of one or more client signal paths included in the expanded path subset by one of the one or more wavelength rings, searching the network topology information, on the predetermined condition, for a corrected ring topology corresponding to each of the one or more wavelength rings, the corrected ring topology including end nodes of one or more client signal paths accommodated by each of the one or more wavelength rings, and correcting each of the one or more wavelength rings to a corrected wavelength ring having the corrected ring topology.

Accordingly, a path passed by a wavelength ring accommodating client signal paths can be corrected and optimized by considering a transmission characteristic such as a transmission distance.

By searching for a ring topology which passes the end nodes (transmission and reception nodes) of a client signal path given at search for a ring topology on the optical network, the number of ring topologies to be searched for can be reduced, so that search for a ring topology can be efficiently performed at high speed.

When a wavelength ring for accommodating actual client signal paths is assigned on the basis of the found ring topology, the ring topology passed by the wavelength ring can be corrected and optimized by considering a transmission characteristic such as a transmission distance. Accordingly, accommodation of client signal paths can be efficiently designed at high speed.

### BRIEF DESCRIPTION OF THE DRAWINGS

FIG. 1 shows an example a network topology of an optical network;

FIG. 2 shows an outline of a procedure of designing accommodation of client signal paths in an optical network according to the present invention;

FIG. 3 shows an example of a configuration of a network topology information according to the present invention;

FIG. 4 shows an example of a configuration of client signal path information according to the present invention;

FIG. 5 shows client signal paths of the present invention associated with the network topology;

FIG. 6 is a flowchart showing a procedure of selecting an expanded ring topology according to the present invention;

FIG. 7 is a flowchart showing a process of selecting an expanded ring topology according to the present invention;

FIG. 8 shows a process of selecting an expanded ring topology according to the present invention;

FIG. 9 shows an example of expanded ring topologies that are eventually selected in the procedure of selecting an expanded ring topology according to the present invention;

FIGS. 10A to 10D illustrate an example of assignments of a wavelength ring and accommodation of client signal paths in an expanded ring topology according to the present invention;

FIG. 11 shows an example of a method for accommodating client signal paths in one wavelength ring;

FIGS. 12A and 12B show an example of optimization of a ring topology of a wavelength ring according to the present invention; and

FIG. 13 shows an example of wavelength rings that are eventually assigned in the present invention.

### DESCRIPTION OF THE PREFERRED EMBODIMENTS

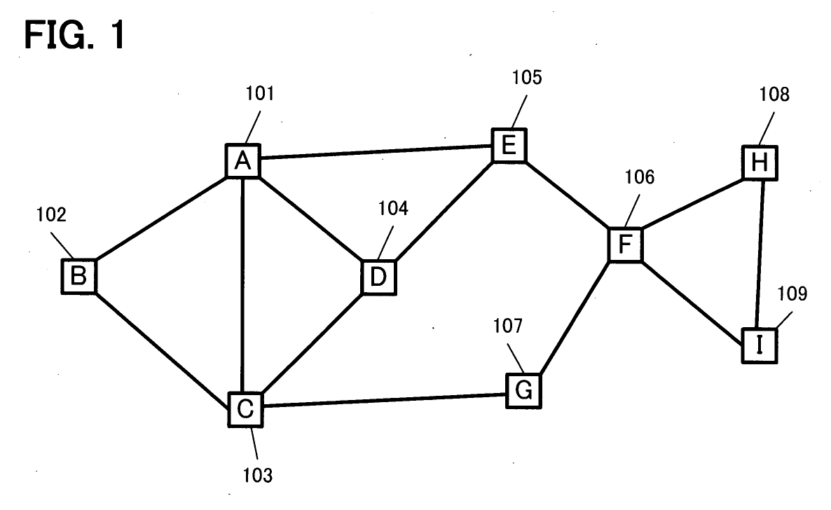

FIG. 1 shows an example of a network topology of an optical network.

The figure shows a connection relationship among nine nodes 101 to 109. The nine nodes 101 to 109 are attached with capital alphabet letters A to I for clarity. In the following description, the respective nodes are referred to by using these alphabet letters.

In a known optical network design, all ring topologies existing in a network topology are searched for and the search result is held. Then, in a stage of designing accommodation in an optical network such as a SONET network, a ring topology adapted to accommodate client signal paths of the SONET network is selected from among the held ring topologies.

However, the number of ring topologies included in the network topology is large. It can be easily estimated that the number of ring topologies increases as the number of nodes increases in a larger network scale. For example, ring topologies including nodes A and B are as follows: A-B-C-A; A-B-C-D-A; A-B-C-D-E-A; A-B-C-G-F-E-A; and A-B-C-G-F-E-D-A. If this is applied to all pairs of nodes, the number of ring topologies is huge.

In the embodiment of the present invention described below, an optical network having the network topology shown in FIG. 1 is described as a representative example for convenience of explanation.

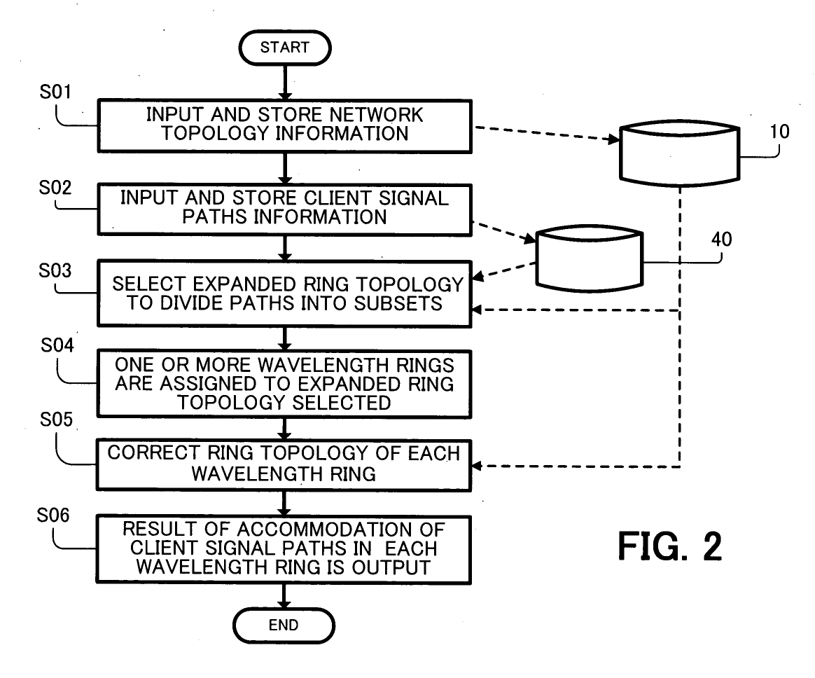

FIG. 2 shows an outline of a procedure of designing accommodation of client signal paths in an optical network according to the present invention.

S01: Information about a connection relationship among nodes of the optical network (network topology information) is input and is held in a network topology information storing part 10. The input information includes identification information of nodes connected to each other and supplementary information that is required for determining a condition when a ring topology is searched for.

S02: Information about client signal paths to be accommodated in the optical network is input and is stored in a client signal path information storing part 40. The client signal path information includes identification information of end nodes and signal bands between the respective end nodes, where the end nodes mean transmission and reception nodes of, each path.

S03: On the basis of the client signal path information stored in the client signal path information storing part 40, the client signal paths are divided into subsets of client signal paths, such that a ring topology (expanded ring topology) capable of accommodating all of the client signal paths included in each subset, whose size is the largest (including the largest number of client signal paths in the subset), is selected by searching the network topology information storing part 10 on a predetermined condition.

S04: One or more wavelength rings of predetermined bandwidths to accommodate the respective client signal paths are assigned to the expanded ring topology selected in step S03.

S05: In each of the wavelength rings assigned in step S04, the network topology information storing part 10 is searched again on the predetermined condition for a ring topology including end nodes accommodated in the wavelength ring. Then, the ring topology through which the wavelength ring passes is corrected to the selected ring topology. Then, the client signal paths are accommodated in a wavelength ring having the corrected ring topology.

S06: A result of accommodation of client signal paths in each wavelength ring is output.

As described above, in the method for designing an optical network according to the present invention, not all ring topologies that can exist in the optical network are searched for, unlike in the known method. Instead, a ring topology capable of accommodating a maximum number of client signal paths is searched for on the predetermined condition on the basis of the network topology information and is selected as an expanded ring topology, and wavelength rings of predetermined bandwidths to actually accommodate client signal paths are assigned to the expanded ring topology. Then, a ring topology capable of accommodating the end nodes of each wavelength ring is searched for on the predetermined condition on the basis of the network topology information, and the ring topology of the wavelength ring is corrected so that the wavelength ring is accommodated in the selected ring topology.

In this way, a load of searching for all ring topologies in the optical network can be reduced, and wavelength rings to optimally accommodate client signal paths can be assigned while considering a transmission characteristic.

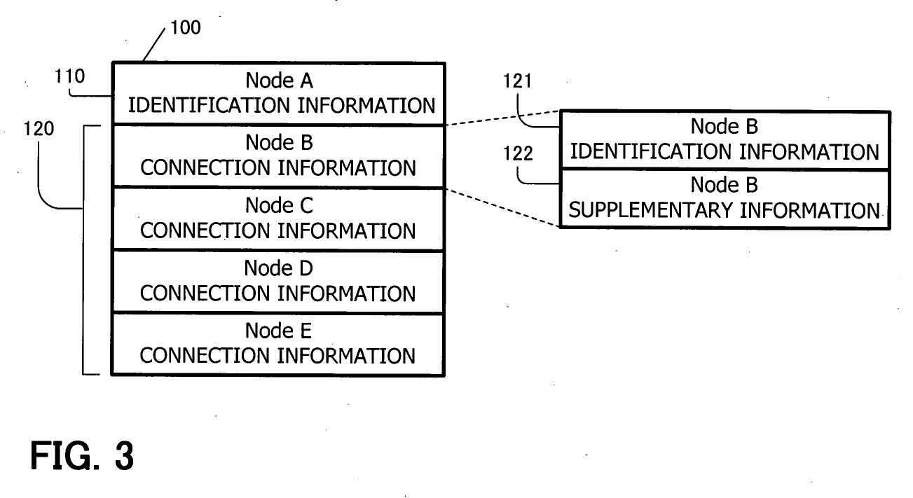

FIG. 3 shows an example of a configuration of the network topology information according to the present invention.

The network topology information is information defining a connection relationship among nodes in the optical network. In other words, the network topology information defines the correspondence between respective nodes connected through optical fibers or the like.

A network topology information storing part 10 is configured as, for example, a set of records storing identification information of each node and connection information between the node and nodes connected thereto.

FIG. 3 shows, as a representative example, a record defining connection information about the node A in the information defining the network topology shown in FIG. 1.

A record 100 includes identification information 110 of a node and connection information 120 about nodes connected thereto. In this example, the identification information 110 about the node A and the connection information 120 about the nodes B, C, D, and E connected to the node A are shown as an example.

Connection information 120 is a set of identification information 121 of each connected node and supplementary information 122 thereof. The length of the connection information 120 varies depending on the number of connected nodes. A weight value of a distance of a connection link between the nodes connected to each other can be set as the supplementary information 122 of the connected node. Accordingly, a weighted distance of a ring topology can be calculated, and a ring topology can be searched for on the condition that the weighted distance is the shortest. Herein, by setting the weight values of the respective connection links to “1”, the smallest number of total hops can be used as the predetermined condition to search for a ring topology.

By setting an OSNR value to the supplementary information 122 of the connected node, the largest OSNR value can be used as the predetermined condition to search for a ring topology.

In the configuration shown in FIG. 3, the length of the connection information 120 of connected nodes is variable. Thus, the length of the record 100 is also variable depending on the number of nodes connected, and the number of records increases as the network scale becomes larger. Therefore, if all ring topologies that can exist in the network topology are to be searched for, a process of sequentially searching the variable-length record and tracing all nodes connected to each node needs to be repeated, which involves an enormous amount of search and process. In the present invention, the nodes to be searched for in the network topology information are narrowed down on the basis of the client signal path information, so that the network can be efficiently designed.

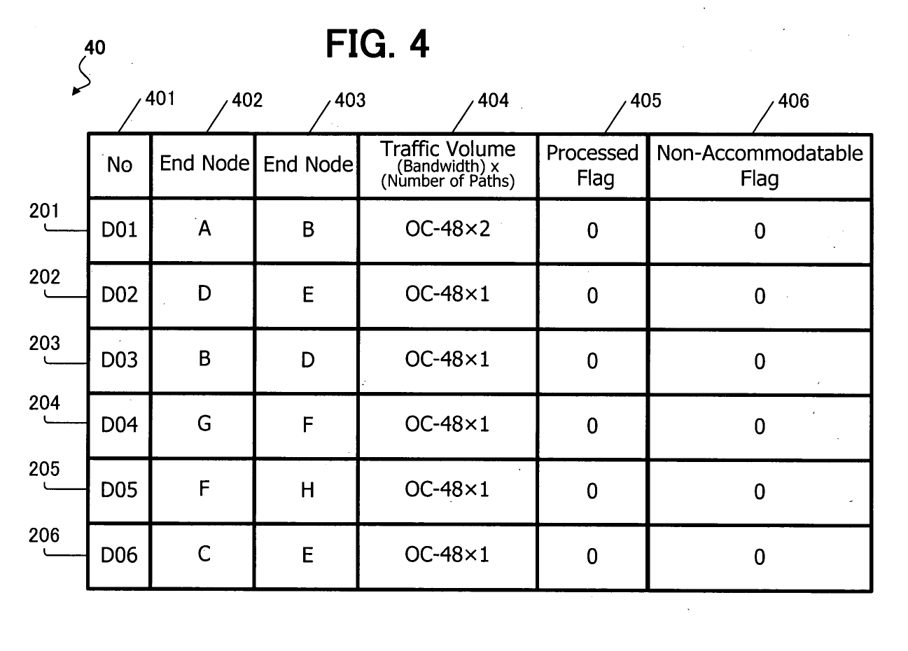

FIG. 4 shows an example of a configuration of the client signal path information according to the present invention. In this example, a set of all client signal paths to be accommodated in the designed optical network is represented as a client signal path list 40 that can be easily processed in a computer. This list 40 serves as an embodiment of the client signal path information storing part 40 shown in FIG. 2.

Each client signal path information used to design accommodation in the optical network can includes identification information of a transmission node and a reception node of traffic (hereinafter referred to as end nodes) and a traffic volume between the end nodes. Herein, the traffic volume is represented by the product of a signal bandwidth and the number of traffic paths between a pair of end nodes.

Each entry in the client signal path list 40 corresponds to a client signal path.

No 401 is identification information of respective client signal path. In this example, identification information D01 to D06 is assigned to six client signal paths.

Reference numerals 402 and 403 denote end nodes corresponding to transmission nodes and reception nodes, respectively. A traffic volume 404 shows a traffic volume between the end nodes 402 and 403. The traffic volume is represented by a multiplexing unit of SONET.

A processed flag 405 is flag information indicating whether a process of selecting an expanded ring topology (described below) has been performed in each entry of the client signal path list 40.

A non-accommodatable flag 406 is flag information indicating whether a ring topology satisfying a predetermined condition has been selected in the process of selecting an expanded ring topology (described below) in each entry of the client signal path list 40.

For example, an entry 201 in the client signal path list 40 corresponds to a client signal path D01 between end nodes A and B, and the traffic volume thereof is OC-48×2. Herein, OC-48 is one of multiplexing levels in SONET standing for “Optical Carrier Level 48”, and corresponds to a traffic volume of a bit rate of 2.48832 Gbps.

Likewise, an entry 202 corresponds to a client signal path D02 between end nodes D and E, and the traffic volume thereof is OC-48×1. An entry 203 corresponds to a client signal path D03 between end nodes B and D, and the traffic volume thereof is OC-48×1. An entry 204 corresponds to a client signal path D04 between end nodes G and F, and the traffic volume thereof is OC-48×1. An entry 205 corresponds to a client signal path D05 between end nodes F and H, and the traffic volume thereof is OC-48×1. An entry 206 corresponds to a client signal path D06 between end nodes C and E, and the traffic volume thereof is OC-48×1.

In this example, an initial value “0” is set in the processed flag 405 and the non-accommodatable flag 406. However, the values of these flags change during the process of selecting an expanded ring topology (described below).

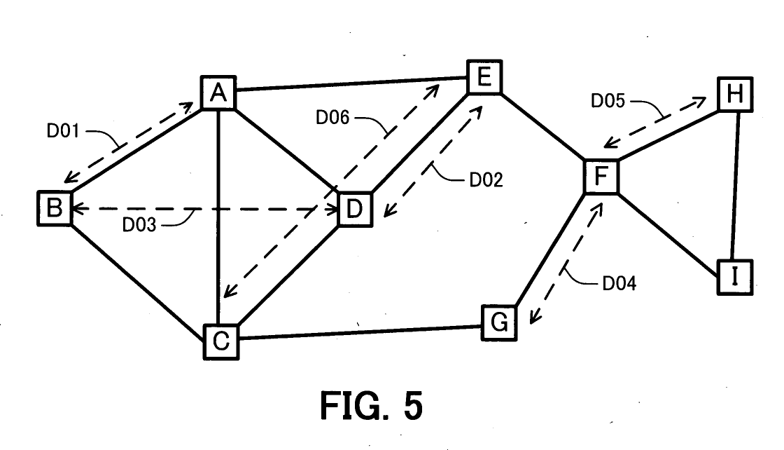

FIG. 5 shows the client signal path information shown in FIG. 4 associated with the network topology.

In order to clarify the correspondence with the client signal paths D01 to D06 shown in FIG. 4, the client signal paths D01 to D06 are indicated by broken-line arrows denoted by reference symbols D01 to D06, respectively. As can be understood by the broken-line arrow D03 indicating the client signal path D03, a client signal path simply shows a pair of end nodes (e.g., nodes B and D in this case) of traffic before an accommodating stage, and does not show a traffic path through which actual traffics flow. Thus, there can typically exist a plurality of traffic paths to realize a client signal path, but one of the traffic paths is determined to the client signal path in the accommodating stage.

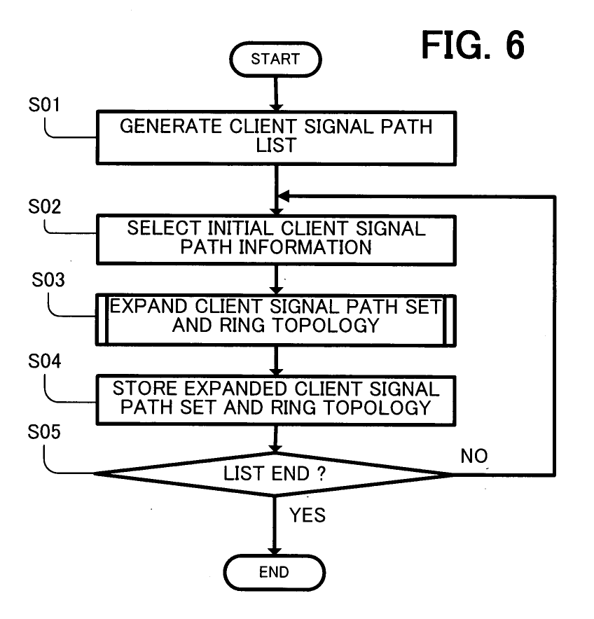

FIG. 6 is a flowchart showing a procedure of selecting an expanded ring topology according to the present invention, where an expanded ring topology capable of accommodating the largest number of client signal paths at one time is selected on the basis of the client signal path list 40 shown in FIG. 4.

In step S01, a client signal path list showing client signal path information of an input SONET signal is generated. Herein, as in the client signal path list 40 shown in FIG. 4, pieces of client signal path information are listed in descending order of a traffic volume between respective end nodes. Alternatively, the pieces of client signal path information may be listed in ascending order of a traffic volume or in descending/ascending order of the total number of traffic paths realizing a client signal path.

The processed flag 405 and the non-accommodatable flag 406 in the client signal path list 40 are initialized (e.g., set to “0”).

In step S02, the top entry among entries where the processed flag 405 is set to “0” in the client signal path list 40 is regarded as initial client signal path information.

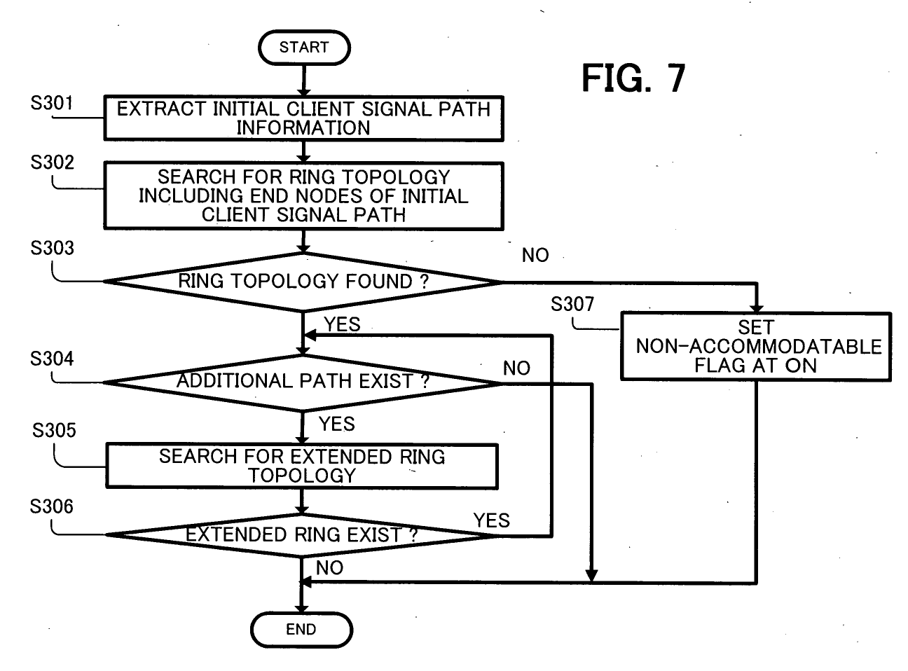

In step S03, the network topology information storing part 10 is searched on a predetermined condition so as to select an expanded ring topology. The process of selecting an expanded ring topology is described below in detail with reference to FIG. 7.

The processed flag 405 of the entry that has been processed in the process of selecting an expanded ring topology is set to ON (“1”), and the entry with the processed flag 4050N is eliminated from the process thereafter.

A set of client signal paths corresponding to the entries processed in this process of selecting an expanded ring topology (subset of client signal paths) can be accommodated in one expanded ring topology selected here. The subset of client signal paths is the largest subset of client signal paths that cannot be expanded any more (expanded subset of an initial client signal path), as described below in FIG. 7.

In step S04, information about the expanded subset of client signal paths obtained by the process of selecting an expanded ring topology in step S03 and information about the corresponding expanded ring are held.

Alternatively, if a result of the process of selecting an expanded ring topology is non-accommodatable, the result may be notified to an operator.

In step S05, whether all of the entries in the client signal path list 40 have been processed is determined on the basis of the processed flag 405. If there is an unprocessed entry (NO), the process returns to step S02. If all of the entries have been processed (YES), the process ends.

With the above-described process, the set of all client signal paths to be accommodated in the optical network is divided into expanded subsets of client signal paths. Each expanded subset of client signal paths can be accommodated in a corresponding expanded ring topology.

FIG. 7 is an example of a flowchart showing a process of selecting an expanded ring topology according to the present invention, where the details of step S03 (the process of selecting an expanded ring topology) in the procedure shown in FIG. 6 is described.

In step S301, initial client signal path information, which is set at a call of this process, is extracted from the client signal path list 40 and is held.

In step S302, the network topology information storing part 10 is searched on the predetermined condition for a ring topology including the end nodes indicated by the initial client signal path information. At the same time, the processed flag of the corresponding entry in the client signal path list 40 is set to “1”.

The predetermined condition can be, for example, any of the following three conditions (a), (b), and (c).

(a) Connection links between the respective nodes in the optical network are weighted, and the distance of a ring topology calculated on the basis of the weight is the shortest.

(b) The total number of hops in the ring topology is the smallest.

(c) OSNR of the ring topology is the largest.

In step S303, if the corresponding ring topology is not found in the search in step S302 (NO), the process proceeds to step S307. If the corresponding ring topology is found (YES), information about the ring topology is held as found ring topology information, and the process proceeds to step S304.

In step S304, among the unprocessed entries (entries in which processed flag is “0”) in the client signal path list 40, additional client signal path information including as end node at least one of the end nodes of the ring topology indicated by the found ring topology information is searched for.

If the additional client signal path information is found (YES), the information is extracted and the process proceeds to step S305. If the additional client signal path information is not found (NO), the process ends.

In step S305, the network topology information storing part 10 is searched on the predetermined condition for a ring topology including the nodes of the ring topology indicated by the found ring topology information and the end nodes indicated by the second client signal path information found in step S304. At the same time, the processed flag is set to “1”.

In step S306, if the corresponding ring topology is found in step S305 (YES), information about the ring topology is held as found ring topology information and the process returns to step S304. If the ring topology is not found (NO), the process ends.

By repeating steps S304 to S306, the ring topology including the end nodes in the first client signal path information can be expanded by adding unprocessed client signal paths.

In step S307, the non-accommodatable flag of the corresponding entry is set to ON (e.g., to “1”), and the process ends.

In the process of selecting an expanded ring topology shown in FIG. 7, it is first determined whether there exist ring topologies including end nodes indicated by the client signal path information selected in a predetermined method (the first client signal path information). If the ring topologies exist, a ring topology satisfying the predetermined condition is selected from among the ring topologies. Then, a client signal path including at least one of the nodes of the selected ring topology is added, and a ring topology that includes the end node of the added client signal path and that satisfies the predetermined condition is searched for. This process is repeated to expand the ring topology so that the ring topology includes the end nodes of as many pieces of client signal path information as possible in the client signal path list 40.

As a result, a ring topology that includes the end nodes shown in the first client signal path information and that satisfies the predetermined condition while reflecting the client signal path information in the client signal path list 40 to the maximum extent, is selected. In this specification, a set of the client signal paths generated in this manner is defined as an expanded subset of client signal paths. A ring topology satisfying the predetermined condition corresponding to the expanded subset of client signal paths is defined as an expanded ring topology.

The above-described search for a ring topology is continued until all of the entries in the client signal path list 40 have been processed. Note that, if a ring topology that includes the end nodes indicated by the first client signal path information and that satisfies the predetermined condition does not exist, it is determined that the client signal path corresponding to the client signal path information cannot be accommodated. At this time, a network designer may be notified that the client signal path cannot be accommodated.

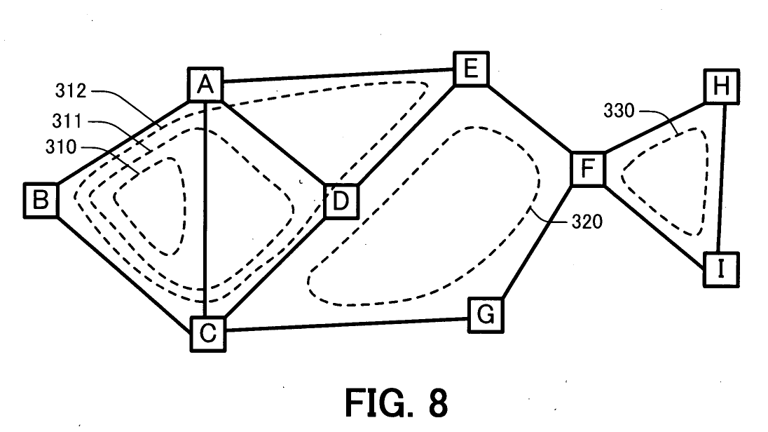

FIG. 8 shows a process of selecting an expanded ring topology according to the present invention. In the figure, broken lines indicate a process where the ring topology that is searched for on the predetermined condition expands during the process of selecting an expanded ring topology described above with reference to FIGS. 6 and 7. Hereinafter, the process of selecting an expanded ring topology on the basis of the client signal path list 40 shown in FIG. 4 is described in the following (1) to (4), in accordance with the order of the steps.

(1) First, the client signal path D01 in the client signal path list 40 is selected as a first client signal path, and a ring topology including the end nodes A and B thereof is searched for on the predetermined condition on the basis of the network topology information storing part 10. Accordingly, a ring topology 310 is found, so that the processed flag 405 of the client signal path D01 is set to ON (“1”). At this time, the method described in the following document can be applied as an algorithm of searching for a ring topology including the end nodes A and B.

Optimal Physical Diversity Algorithms and Survivable Networks” (Ramesh Bhandari, Proceedings of the 2^{nd} IEEE Symposium on Computers and Communications (ISCC '97)

(2) Then, a client signal path (second client signal path) including at least one of the end nodes A and B of the client signal path D01 included in the ring topology 310 is searched for from the top in the client signal path list 40. In this case, among the end nodes B and D of the entry 203, the node B is included in the ring topology 310, so that the client signal path D03 is selected.

(3) A ring topology which includes the end nodes A and B of the client signal path D01 included in the ring topology 310 and includes the end nodes B and D indicated by the client signal path information D03, that is, a ring topology including the end nodes A, B, and D, is searched for on the predetermined condition in the network topology information storing part 10, so that a ring topology 311 is obtained. At this time, the processed flag 405 of the client signal path information D03 is set to ON (“1”).

(4) Since the ring topology 311 was found in process (3), a client signal path (a second client signal path) including an end node that matches any of the end nodes A, B, and D (indicated by the client signal path D01 and D03) and is included in the ring topology 311 is searched for among the unprocessed entries in the client signal path list 40.

(5) In this case, the client signal path D02 (end nodes: D and E) is selected. Then, the network topology information storing part 10 is searched on the predetermined condition for a ring topology including the end nodes A, B, and D of the client signal path information D01 and D03 included in the ring topology 311 and the end nodes D and E of the client signal path D03, so that a ring topology 312 is obtained. At this time, the processed flag of the client signal path information D02 is set to ON (“1”).

(6) Since the ring topology 312 was found in process (5), client signal path (second client signal path) including an end node that matches any of the nodes A, B, D, and E of the client signal path D01, D02, and D03 included in the ring topology 312 is searched for among the unprocessed entries in the client signal path list 40.

In this case, the client signal path D06 (end nodes: C and E) is selected. Then, the network topology information storing part 10 is searched on the predetermined condition for a ring topology including the end nodes A, B, D, and E of the client signal paths D01, D02, and D03 included in the ring topology 312 and the end nodes C and E of the client signal path D06. However, since the ring topology 312 includes the end nodes C and E of the client signal path D06, the ring topology 312 is obtained as a search result. At this time, the processed flag of the client signal path D06 is set to ON (“1”).

(7) Since the ring topology 312 was found in process (6), a client signal path (second client signal path) including an end node that matches any of the end nodes A, B, C, D, and E (of the client signal path information D01, D02, D03, and D06) which are included in the ring topology 312, is searched for among the unprocessed entries in the client signal path list 40.

However, since an unprocessed entry including any of the nodes A, B, C, D, and E does not exist in the client signal path list 40, the process of searching for a ring topology once ends.

Herein, all of the nodes A, B, C, D, and E existing in the expanded ring topology 312 are compared with the end nodes A, B, C, D, and E of the client signal paths D01, D02, D03, and D06 included in the expanded ring topology 312. At this time, the nodes on both sides match, and thus an expanded subset of client signal paths including the client signal paths D01, D02, D03, and D06, and the expanded ring topology 312 can be obtained.

(8) Then, it is determined whether the client signal path list 40 has an unprocessed entry. In this case, unprocessed entries 204 and 205 exist, and thus a process of selecting an expanded ring topology is performed by regarding the client signal path D04 of the top unprocessed entry 204 in the client signal path list 40 as first client signal path. As a result, a ring topology 320 that includes the end nodes G and F of the client signal path D04 and that satisfies the predetermined condition is found in the network topology information storing part 10. At the same time, the processed flag of the entry 204 is set to ON (“1”).

Since an unprocessed client signal path (second client signal path) including any of the end nodes G and F of the client signal path included in the ring topology 320 does not exist, the process of searching for a ring topology once ends.

Comparing all of the nodes C, D, E, F, and G existing in the expanded ring topology 320 with the end nodes G and F of the client signal path D04 included in the expanded ring topology 320, only the nodes G and F are common to the both sides.

If the both sides do not match, an unprocessed client signal path (second client signal path) including any of the nodes C, D, E, F, and G existing in the expanded ring topology 320 is searched for among the unprocessed entries in the client signal path list 40.

Since the unprocessed client signal path (second client signal path) including any of the nodes C, D, E, F, and G existing in the expanded ring topology 320 does not exist, an expanded subset of client signal paths including only the client signal path D04 as an element and the expanded ring topology 320 can be obtained.

(9) Then, client signal path (first client signal path) of the top unprocessed entry in the client signal path list 40 is selected.

Herein, the client signal path D05 is selected. Thus, the network topology information storing part 10 is searched on the predetermined condition for a ring topology including the end nodes F and H of the client signal path D05. Accordingly, a ring topology 330 is selected, so that the processed flag of the client signal path D05 is set to ON (“1”).

(10) There is no unprocessed entry in the client signal path list 40 and second client signal path does not exist any more. Thus, the process of searching for a ring topology once ends.

At this time, an expanded subset of client signal paths including only the client signal path D05 as an element and the expanded ring topology 330 can be obtained.

(11) In the above-described process, all of the entries in the client signal path list 40, that is, the entire client signal path information, has been processed, and the process ends.

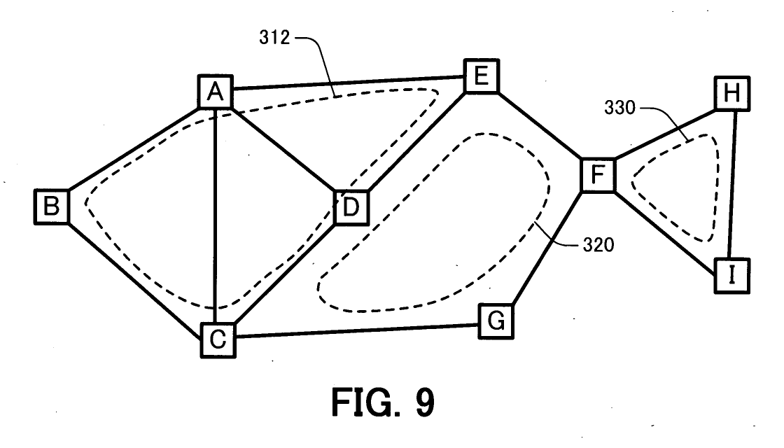

FIG. 9 shows expanded ring topologies that have eventually been selected in the above-described procedure. In the figure, three expanded ring topologies 312, 320, and 330 are selected.

The expanded ring topology 312 is a ring topology of A-B-C-D-E-A; the expanded ring topology 320 is a ring topology of C-G-F-E-D-C; and the expanded ring topology 330 is a ring topology of F-I-H. The client signal paths that can be accommodated in the expanded ring topology 312 are four client signal paths D01, D02, D03, and D04. The client signal path that can be accommodated in the expanded ring topology 320 is the client signal path D04. The client signal path that can be accommodated in the expanded ring topology 330 is the client signal path corresponding to the client signal path D05.

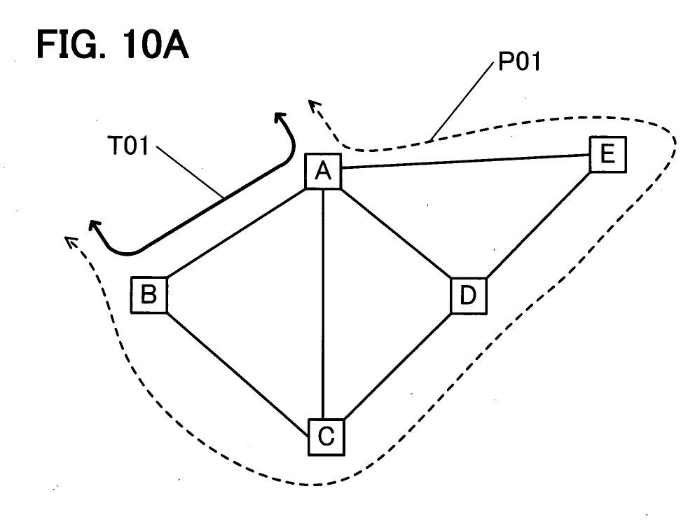

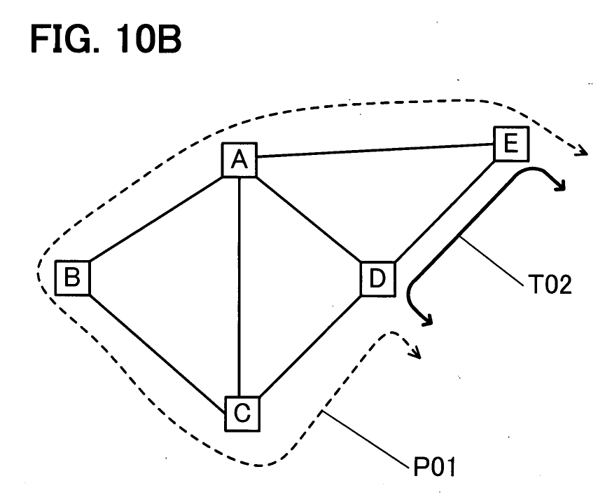

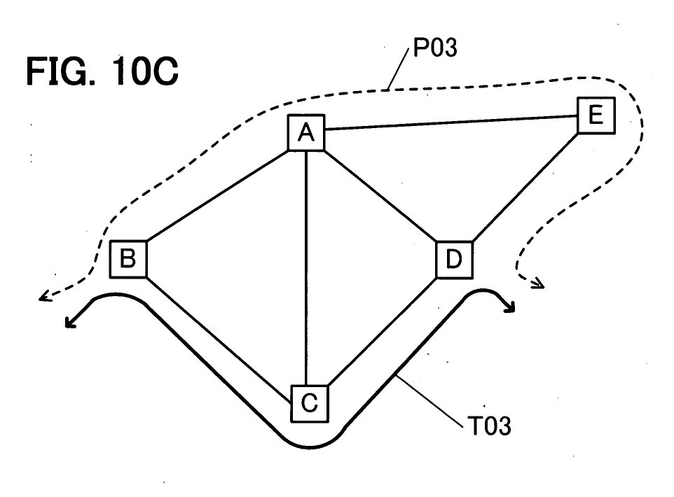

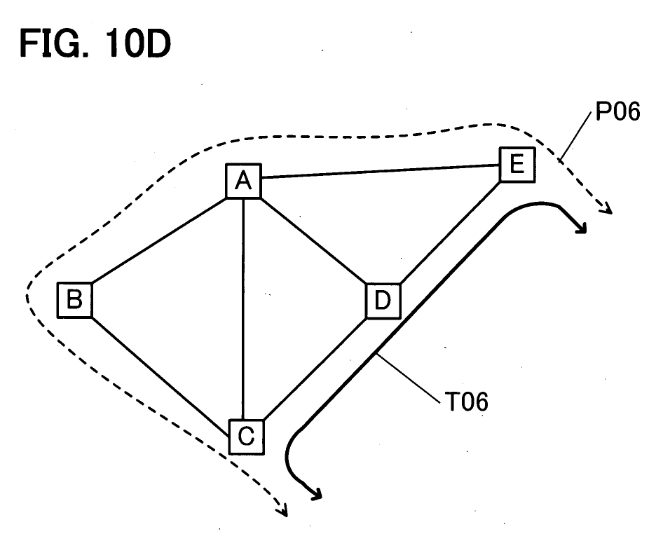

FIGS. 10A to 10D illustrate assignment of a wavelength ring and accommodation of client signal paths in an expanded ring topology.

The figures show a method for accommodating the respective client signal paths shown in the client signal path list 40 in FIG. 4 by assigning them to a wavelength ring of a predetermined bandwidth passing the expanded ring topologies shown in FIG. 9.

Herein, the wavelength ring has, for example, a predetermined bandwidth of 10 Gbps, and the expanded ring topology 312 among the expanded ring topologies shown in FIG. 9 is described as a representative example.

In FIGS. 10A to 10D, traffic flows T01 and P01 correspond to the client signal path D01 in the client signal path list 40; traffic flows T02 and P02 correspond to the client signal path D02; traffic flows T03 and P03 correspond to the client signal path D03; and traffic flows T06 and P06 correspond to the client signal path D06.

The solid-line arrows T01, T02, T03, and T06 indicate traffic flows in a normal mode, whereas the broken-line arrows P01, P02, P03, and P06 indicate traffic flows in a protection mode corresponding to the traffic flows T01, T02, T03, and T06 in the normal mode. The following description is made on the assumption of a case of UPSR (uni-directional path switched ring) of a SONET ring for convenience.

First, the traffic volume 404 of each client signal path is checked by referring to the client signal path list 40 shown in FIG. 4.

FIG. 10A shows the traffic flow T01 in the normal mode and the traffic flow P01 in the protection mode corresponding to the client signal path D01. As can been understood by the traffic flows shown in the figure, the path (OC-48×2) corresponding to the traffic volume of the client signal path D01 needs to be accommodated in a ring shape in order to accommodate the client signal path D01.

FIG. 10B shows the traffic flow T02 in the normal mode and the traffic flow P02 in the protection mode corresponding to the client signal path D02. The path (OC-48×1) corresponding to the traffic volume of the client signal path D02 needs to be accommodated in a ring shape in order to accommodate the client signal path D02.

FIG. 10C shows the traffic flow T03 in the normal mode and the traffic flow P03 in the protection mode corresponding to the client signal path D03. The path (OC-48×1) corresponding to the traffic volume of the client signal path D03 needs to be accommodated in a ring shape in order to accommodate the client signal path D03.

FIG. 10D shows the traffic flow T06 in the normal mode and the traffic flow P06 in the protection mode corresponding to the client signal path D06. The path (OC-48×1) corresponding to the traffic volume of the client signal path D06 needs to be accommodated in a ring shape in order to accommodate the client signal path D06.

However, when all of the client signal paths D01, D02, D03, and D06 are to be accommodated, the total traffic volume corresponds to OC-48×5, which exceeds 10 Gbps. Therefore, all of the client signal paths cannot be accommodated in one wavelength ring of 10 Gbps, but two wavelength rings are required.

In that case, for example, since the total traffic volume of the client signal paths D01, D02, and D03 is OC-48×4 corresponding to OC-192×1, which can be accommodated in one wavelength ring of 10 Gbps, the client signal path D06 is accommodated in another wavelength ring.

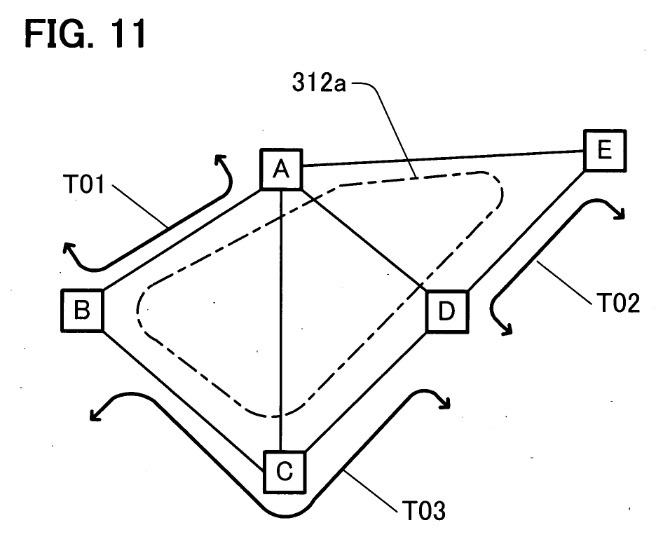

FIG. 11 shows a method for accommodating the traffic flows of the client signal paths D01, D02, and D03 shown in FIGS. 10A to 10C in one wavelength ring. In this figure, illustration of the traffic flows in the protection mode is omitted.

In this case, a wavelength ring 312a is assigned so as to pass the expanded ring topology 312 obtained in FIG. 8. The end nodes of the client signal path D01 are the nodes A and B, the end nodes of the client signal path D02 are the nodes D and E, and the end nodes of the client signal path D03 are the nodes B and D.

Therefore, the end nodes included in the wavelength ring 312a are the nodes A, B, C, D, and E. Even if a path of a wavelength ring including these end nodes is searched for on the predetermined condition on the basis of the network topology information 10, it is impossible to correct the ring topology to make it smaller, and thus the ring topology 312 selected as an expanded ring topology is determined to be an optimal ring topology. The client signal paths D01, D02, and D03 are accommodated in the wavelength ring 312a passing through the optimal ring topology 312.

As a method for optimally accommodating client signal paths in the ring topology described with reference to the figure (expanded ring topology), the method described in Japanese Patent Application No. 2006-123908 “Method for designing optical network”, filed on Apr. 27, 2006, can be applied.

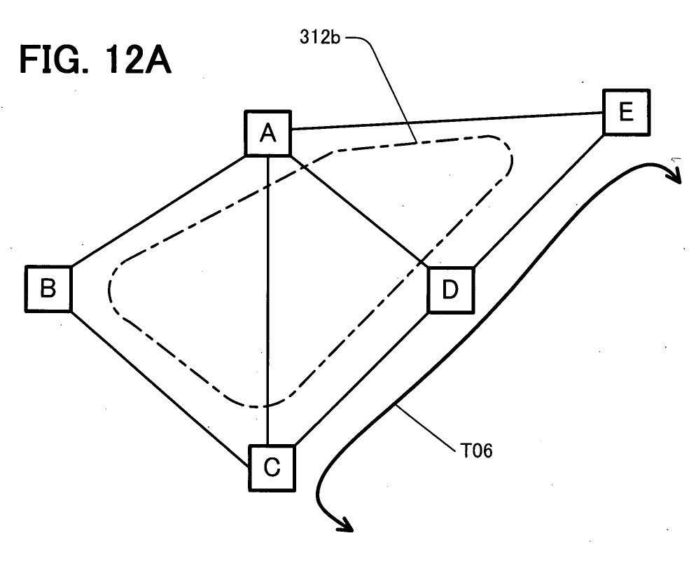

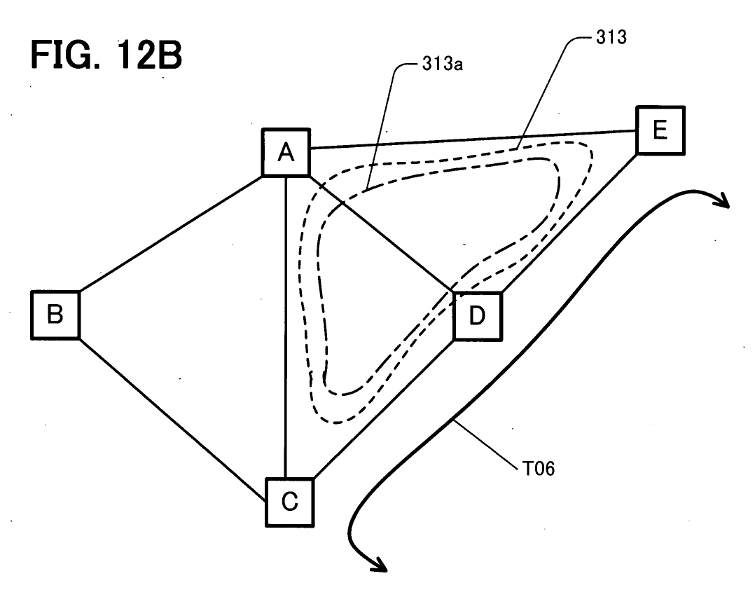

FIGS. 12A and 12B show an example of optimization of a ring topology of a wavelength ring according to the present invention. This example shows a case where the traffic flow of the client signal path D06 shown in FIG. 10D is accommodated in a wavelength ring.

A wavelength ring 312b shown in FIG. 12A is a wavelength ring to accommodate the traffic flows T06 and P06 shown in FIG. 10D. In this figure, illustration of the traffic P06 in the protection mode is omitted.

The wavelength ring 312b in this stage is a wavelength ring passing through the expanded ring topology 312 shown in FIG. 9.

Herein, the end nodes of the client signal path D06 to be accommodated in the wavelength ring 312b are the nodes C and E. When a ring topology including the nodes C and E is searched for on the predetermined condition on the basis of the network topology information 10, a ring topology 313 that is smaller than the expanded ring topology 312 is found, as shown in FIG. 12B. Then, the path of the wavelength ring 312b is corrected so that the wavelength ring 312b passes through the re-searched ring topology 313, obtaining a wavelength ring 313a. Then, the client signal path D06 is accommodated in the corrected wavelength ring 313a. In FIG. 12B, the ring topology 313 and the wavelength ring 313a are shown in parallel in order to prevent complicated illustration. Actually, however, the wavelength ring 313a passes through the ring topology 313.

As described above, the wavelength ring 312b along the expanded ring topology 312 includes a redundant path A-B-C. On the other hand, the corrected wavelength ring 313a does not include a redundant path, so that an optimal wavelength ring can be assigned considering a transmission characteristic such as a transmission distance.

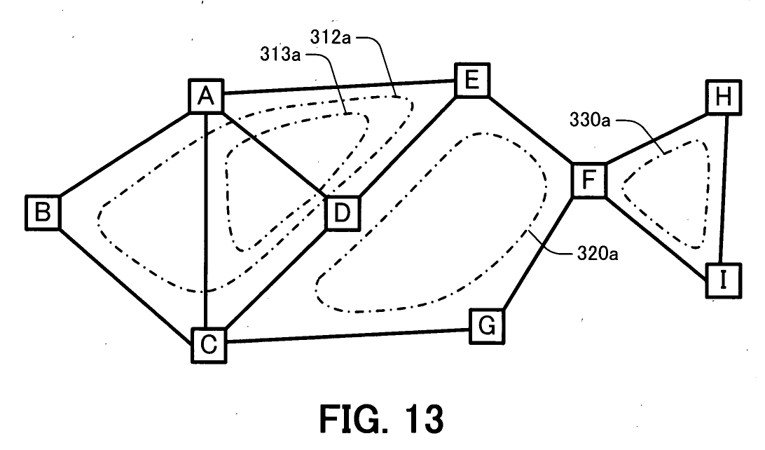

FIG. 13 shows wavelength rings that are eventually assigned.

In the network topology shown in FIG. 1, the set of client signal paths shown in the client signal path list 40 shown in FIG. 4 is divided into subsets of client signal paths. The subset of client signal paths including the client signal paths D01, D02, D03, and D06 is accommodated in two wavelength rings: the wavelength rings 312a and 313a, the subset of client signal paths including the client signal path D04 is accommodated in a wavelength ring 320a, and the subset of client signal paths including the client signal path D05 is accommodated in a wavelength ring 330a. Each of the wavelength rings is selected so as to pass through an optimal ring topology satisfying the predetermined condition.

As described above, in the present invention, ring topologies are narrowed down to those adapted to client signal paths on the basis of input client signal path information, and a ring topology satisfying the predetermined condition is selected from among the ring topologies by searching network topology information. Accordingly, the load of searching for a ring topology is reduced and an operation of selecting a wavelength ring appropriate to accommodate client signal paths is automated. As a result, accommodation of client signal paths can be efficiently designed.

In the above-described embodiment, the optical network having the network topology shown in FIG. 1 is described as a representative example for convenience. Also, the present invention can be applied to a network having another arbitrary topology.

In the above-described embodiment, the WDM network is used as a representative example of an optical network and the SONET signal is used as a representative example of a client signal. However, an optical network other than the WDM network and a client signal other than the SONET signal can be applied without affecting the essence of the present invention.

What is claimed is:

1. A method for designing accommodation of client signal paths in an optical network, comprising:
providing network topology information defining a connection relationship between nodes of the optical network;
providing client signal path information for each client signal path, the client signal path information including end node identification information and path bandwidth information, the end node identification information identifying a pair of end nodes comprising a transmitting end node and a receiving end node of the client signal path, the path bandwidth information indicating a bandwidth of the client signal path between the pair of end nodes;
a first path subset selecting step of selecting a first path subset of a total path set of client signal paths to be accommodated in the optical network;
a first ring selecting step of selecting a first ring topology including end nodes of all client signal paths included in the first path subset;
a first path expanding step of expanding the first path subset into a second path subset of the total path set by adding to the first path subset an additional client signal path that is not included in the first path subset and that has at least one node of the first ring topology as an end node thereof; and
a first ring expanding step of searching the network topology information for a second ring topology on a predetermined condition, the second ring topology including all nodes of the first ring topology and a pair of end nodes of the additional client signal path.

2. The method of claim 1, further comprising:
a second path subset selecting step of selecting the second path subset as a first path subset;
a second ring selecting step of selecting the second ring topology as a first ring topology;
a second path expanding step of expanding the first path subset into a second path subset by performing the first path expanding step on the first path subset selected by the second path subset selecting step;
a second ring expanding step of expanding the first ring topology into the second ring topology by performing the first ring expanding step on the first ring topology selected by the second ring selecting step; and
a expansion repeating step of repeating the second path subset selecting step, the second ring selecting step, the second path expanding step, and the second ring expanding step, until the first path subset cannot be expanded any more or until the first ring topology cannot be expanded any more.

3. The method of claim. 2, wherein
the second path subset selecting step selects, as a first path subset, an initial client signal path from the total path set of client signal paths;
the second ring selecting step selects, as the first ring topology, a ring topology including a pair of end nodes of the selected initial client signal path; and
the second path subset and the second ring topology finally obtained by the expansion repeating step are determined to be an expanded path subset and an expanded ring topology of the selected initial client signal path, respectively.

4. The method of claim 3, further comprising:
assigning to the expanded ring topology one or more wavelength rings each having a predetermined wavelength and bandwidth; and
accommodating each of one or more client signal paths included in the expanded path subset by one of the one or more wavelength rings.

5. The method of claim 4, further comprising:
searching the network topology information, on the predetermined condition, for a corrected ring topology corresponding to each of the one or more wavelength rings, the corrected ring topology including end nodes of one or more client signal paths accommodated by each of the one or more wavelength rings; and
correcting each of the one or more wavelength rings to a corrected wavelength ring having the corrected ring topology.

6. The method of claim 3, further comprising:
notifying that the selected client signal path cannot be accommodated when the first ring topology cannot be expanded any more by the expansion repeating step.

7. The method of claim 3, further comprising:
a total path set redefining step of redefining a set of client signal paths obtained by removing the expanded path subset of the selected client signal path from the total path set of client signal paths, as a total path set of client signal paths;
a total path set expansion step of obtaining the expanded path subset and the expanded ring topology with respect to the total path set of client signal paths redefined by the total path set redefining step; and
a total path set expansion repeating step of repeating the total path set redefining step and the total path set expansion step until a total path set of client signal paths cannot be redefined any more by the total path set redefining step.

8. The method of claim 1, wherein the first ring expanding step is performed by searching the network topology information on the predetermined condition of minimizing a weighted path length of the second ring topology on the basis of weighted distance information included in the network topology information.

9. The method of claim 1, wherein the first ring expanding step is performed by searching the network topology information on the predetermined condition of minimizing a hop count of the second ring topology on the basis of hop count information included in the network topology information.

10. The method of claim 1, wherein the first ring expanding step is performed by searching the network topology information on the predetermined condition of maximizing an OSNR value of the second ring topology on the basis of OSNR information included in the network topology information.

11. An optical network configured by a method of designing accommodation of client signal paths to the optical network, the method comprising:
providing network topology information defining a connection relationship between nodes of the optical network;
providing client signal path information for each client signal path, the client signal path information including end node identification information and path bandwidth information, the end node identification information identifying a pair of end nodes comprising a transmission end and a reception end of the client signal path, the path bandwidth information indicating a bandwidth of the client signal path between the pair of end nodes;
a first path subset selecting step of selecting a first path subset of a total path set of client signal paths to be accommodated in the optical network;
a first ring selecting step of selecting a first ring topology including end nodes of all client signal paths included in the first path subset;
a first path expanding step of expanding the first path subset into a second path subset of the total path set by adding to the first path subset additional client signal path that is not included in the first path subset and that has at least one node of the first ring topology as an end node; and
a first ring expanding step of searching the network topology information for a second ring topology on a predetermined condition, the second ring topology including all nodes of the first-ring topology and the end nodes of the additional client signal path.

12. The optical network of claim 11, the method further comprising:
a second path subset selecting step of selecting the second path subset as a first path subset;
a second ring selecting step of selecting the second ring topology as a first ring topology;
a second path expanding step of expanding the first path subset into a second path subset by performing the first path expanding step on the first path subset selected by the second path subset selecting step;
a second ring expanding step of expanding the first ring topology into the second ring topology by performing the first ring expanding step on the first ring topology selected by the second ring selecting step; and
a expansion repeating step of repeating the second path expanding step and the second ring expanding step until a second path subset cannot be selected any more or until the second ring topology cannot be selected any more.

13. The optical network of claim 12, wherein
the first path subset selecting step selects, as a first path subset, an initial client signal path from the total path set of client signal paths;
the first ring selecting step selects, as the first ring topology, a ring topology including a pair of end nodes of the selected client signal path by searching the network topology information on the predetermined condition; and
the second path subset and the second ring topology finally obtained by the expansion repeating step are determined to be an expanded path subset and an expanded ring topology of the selected initial client signal path, respectively.

14. A computer readable medium storing instructions for allowing a computer system to execute a method for designing accommodation of client signal paths to an optical network, the method comprising:
providing network topology information defining a connection relationship between nodes of the optical network;
providing client signal path information for each client signal path, the client signal path information including end node identification information and path bandwidth information, the end node identification information identifying a pair of end nodes comprising a transmission end and a reception end of the client signal path, the path bandwidth information indicating a bandwidth of the client signal path between the pair of end nodes;
a first path subset selecting step of selecting a first path subset of a total path set of client signal paths to be accommodated in the optical network;
a first ring selecting step of selecting a first ring topology including end nodes of all client signal paths included in the first path subset;
a first path expanding step of expanding the first path subset into a second path subset of the total path set by adding to the first path subset additional client signal path that is not included in the first path subset and that has at least one node of the first ring topology as an end node; and
a first ring expanding step of searching the network topology information for a second ring topology on a predetermined condition, the second ring topology including all nodes of the first ring topology and the end nodes of the additional client signal path.

15. The computer readable medium of claim 14, the method further comprising:
a second path subset selecting step of selecting the second path subset as a first path subset;
a second ring selecting step of selecting the second ring topology as a first ring topology;
a second path expanding step of expanding the first path subset into a second path subset by performing the first path expanding step on the first path subset selected by the second path subset selecting step;
a second ring expanding step of expanding the first ring topology into the second ring topology by performing the first ring expanding step on the first ring topology selected by the second ring selecting step; and
a expansion repeating step of repeating the second path expanding step and the second ring expanding step until a second path subset cannot be selected any more or until the second ring topology cannot be selected any more.

16. The computer readable medium of claim 15, wherein
the first path subset selecting step selects, as a first path subset, an initial client signal path from the total path set of client signal paths;
the first ring selecting step selects, as the first ring topology, a ring topology including a pair of end nodes of the selected client signal path by searching the network topology information on the predetermined condition; and
the second path subset and the second ring topology finally obtained by the expansion repeating step are determined to be an expanded path subset and an expanded ring topology of the selected initial client signal path, respectively.
